(19) United States
(12) Patent Application Publication
(10) Pub. No.: US 2026/0302654 A1
(43) Pub. Date: Oct. 1, 2026

(54) CONNECTION MEMBER

(71) Applicant: Sumitomo Wiring Systems, Ltd., Yokkaichi-shi, Mie (JP)

(72) Inventor: Hideki GOTO, Yokkaichi-shi, Mie (JP)

(73) Assignee: Sumitomo Wiring Systems, Ltd., Yokkaichi-shi, Mie (JP)

(21) Appl. No.: 18/996,584

(22) PCT Filed: Jun. 28, 2023
(86) PCT No.: PCT/JP2023/024008

§ 371 Date: Jan. 17, 2025

(30) Foreign Application Priority Data
Jul. 19, 2022 (JP) 2022-114966

(51) Int. Cl. H01R 4/48

(52) U.S. Cl. CPC H01R 4/4811; H01R 4/4846

(57) ABSTRACT

A connection member configured to connect a plurality of superimposed bus bars includes a tubular frame into which the bus bars are to be inserted and a first bent plate portion that protrudes into the tubular frame.

### CROSS-REFERENCE TO RELATED APPLICATIONS

This application is the U.S. national stage of PCT/JP2023/024008 filed on Jun. 28, 2023, which claims priority of Japanese Patent Application No. JP 2022-114966 filed on Jul. 19, 2022, the contents of which are incorporated herein.

### TECHNICAL FIELD

The present disclosure relates to a connection member configured to connect conductive plates to each other.

### BACKGROUND

Conventionally, circuits using bus bars to conduct relatively high currents are installed in vehicles. Additionally, in recent years, with the expansion of vehicle functions, the values of the currents flowing through bus bars have also been increasing.

Meanwhile, JP 2014-79093A discloses a power supply device that includes a relay with an openable and closable contact and an excitation coil for switching the opening and closing of the contact, the contact of the relay being electrically connected to a bus bar, the bus bar being provided with a heat dissipation mechanism, and thus the bus bar being able to serve as both a current path and a heat dissipation path.

When connecting bus bars like those described above to other bus bars, special techniques such as ultrasonic welding, TOX (registered trademark) Clinching, and laser joining are generally used.

However, these techniques, which require special devices, have problems such as increased operating costs. However, the power supply device disclosed in JP 2014-79093A does not consider these problems and cannot solve them.

Therefore, an object of the present disclosure is to provide a connection member configured to connect conductive plates to each other more easily and at a lower cost.

### SUMMARY

A connection member according to an embodiment of the present disclosure is a connection member configured to connect a plurality of superposed conductive plates, the connection member including a tubular frame into which the conductive plates are to be inserted and a protruding portion that protrudes into the tubular frame.

### Advantageous Effects

According to the present disclosure, it is possible to provide a connection member configured to connect conductive plates to each other more easily and at a lower cost.

### BRIEF DESCRIPTION OF DRAWINGS

FIG. 1 is a perspective view showing a connection member according to Embodiment 1, as viewed from one side.

FIG. 2 is a perspective view showing the connection member according to Embodiment 1, as viewed from another side.

FIG. 3 is a cross-sectional view taken along line III-III in FIG. 1.

FIG. 4 is an explanatory diagram showing a state in which two superposed bus bars are electrically connected to each other by the connection member of Embodiment 1.

FIG. 5 is a cross-sectional view taken along line V-V in FIG. 4.

FIG. 6 is an exemplary illustration of an engaging portion formed in one of the bus bars and an engaged portion formed in the other bus bar.

FIG. 7 is a perspective view showing a connection member according to Embodiment 2, as viewed from one side.

FIG. 8 is a perspective view showing the connection member according to Embodiment 2, as viewed from another side.

FIG. 9 is a cross-sectional view taken along line IX-IX in FIG. 7.

FIG. 10 is a perspective view of the connection member, showing the exterior of a flat plate portion.

FIG. 11 is an explanatory diagram showing a state in which two superposed bus bars are electrically connected to each other by the connection member of Embodiment 2.

FIG. 12 is a cross-sectional view taken along line XII-XII in FIG. 11.

### DETAILED DESCRIPTION OF PREFERRED EMBODIMENTS

First, embodiments of the present disclosure will be listed and described. At least some of the embodiments described below may be combined with each other as appropriate.

In a first aspect, a connection member according to an embodiment of the present disclosure is a connection member configured to connect a plurality of superposed conductive plates, the connection member including a tubular frame into which the conductive plates are to be inserted and a protruding portion that protrudes into the tubular frame.

According to such an embodiment, an outer main surface of the plurality of superposed conductive plates is pressed by the protruding portion when inserted into the tubular frame. Thus, the plurality of conductive plates are electrically connected to each other.

In a second aspect, in a connection member according to an embodiment of the present disclosure, the protruding portion includes a first bent plate portion that is continuous with an edge of a first wall of the tubular frame and bent into the tubular frame.

According to such an embodiment, during insertion of the plurality of superposed conductive plates into the tubular frame, the first bent plate portion deforms, and an outer main surface of the plurality of conductive plates is pressed by the deformed first bent plate portion. Thus, the plurality of conductive plates are electrically connected to each other.

In a third aspect, in a connection member according to an embodiment of the present disclosure, the protruding portion includes a second bent plate portion that is continuous with an edge of a second wall of the tubular frame and bent into the tubular frame, the second wall being opposite the first wall, and the first bent plate portion and the second bent plate portion face each other.

According to such an embodiment, during insertion of the plurality of superposed conductive plates into the tubular frame, the first bent plate portion and the second bent plate portion deform, and two outer main surfaces of the plurality of conductive plates are pressed in a direction of superposition by the deformed first and second bent plate portions, respectively. Thus, the plurality of conductive plates are electrically connected to each other.

In a fourth aspect, in a connection member according to an embodiment of the present disclosure, an end portion of the first bent plate portion and an end portion of the second bent plate portion are spaced apart from an inner surface of the tubular frame.

According to such an embodiment, the end portion of the first bent plate portion and the end portion of the second bent plate portion are spaced apart from the inner surface of the tubular frame. Therefore, during insertion of the plurality of superposed conductive plates into the tubular frame, the first bent plate portion and the second bent plate portion easily deform. The deformed first and second bent plate portions respectively press the two outer main surfaces of the plurality of conductive plates. Thus, the plurality of conductive plates are electrically connected to each other.

In a fifth aspect, in a connection member according to an embodiment of the present disclosure, the end portion of the first bent plate portion and the end portion of the second bent plate portion are curved toward the first wall and the second wall, respectively.

According to such an embodiment, the end portion of the first bent plate portion and the end portion of the second bent plate portion are curved toward the first wall and the second wall, respectively. Therefore, during insertion of the plurality of superposed conductive plates into the tubular frame, the first bent plate portion and the second bent plate portion deform, and their end portions abut against the first wall and the second wall, respectively, which increases the restoring force to return the first and second bent plate portions to their original shapes. Thus, the deformed first and second bent plate portions respectively press the two outer main surfaces of the plurality of conductive plates in the direction of superposition more strongly.

In a sixth aspect, in a connection member according to an embodiment of the present disclosure, the protruding portion includes an embossed portion formed by locally raising the first wall of the tubular frame.

According to such an embodiment, during insertion of the plurality of superposed conductive plates into the tubular frame, the embossed portion deforms, and an outer main surface of the plurality of conductive plates is pressed by the deformed embossed portion. Thus, the plurality of conductive plates are electrically connected to each other.

In a seventh aspect, a connection member according to an embodiment of the present disclosure includes a pair of semi-cylindrical portions provided on an opposite side to the first wall and arranged side-by-side in a radial direction.

According to such an embodiment, during insertion of the plurality of superposed conductive plates into the tubular frame, the pair of semi-cylindrical portions, as well as the embossed portion, deform, and the two outer main surfaces of the plurality of conductive plates are pressed in the direction of superposition by the deformed embossed portion and the deformed semi-cylindrical portions, respectively. Thus, the plurality of conductive plates are electrically connected to each other.

In an eight aspect, in a connection member according to an embodiment of the present disclosure, each of the semi-cylindrical portions is curved to protrude outward from the tubular frame.

According to such an embodiment, during insertion of the plurality of superposed conductive plates into the tubular frame, the embossed portion and the pair of semi-cylindrical portions deform, and circumferential ends of the semi-cylindrical portions and a protruding end of the embossed portion respectively abut against the two outer main surfaces of the plurality of conductive plates. In this state, the deformed embossed portion and the deformed semi-cylindrical portions respectively press the two outer main surfaces of the plurality of conductive plates. Thus, the plurality of conductive plates are electrically connected to each other.

In a ninth aspect, in a connection member according to an embodiment of the present disclosure, the pair of semi-cylindrical portions are separate from each other.

According to such an embodiment, the pair of semi-cylindrical portions are separate from each other, which increases the degree of freedom of each semi-cylindrical portion. More specifically, when deforming due to the insertion of the plurality of superposed conductive plates into the tubular frame, each semi-cylindrical portion can freely deform according to unevenness of the outer main surface of these conductive plates. Thus, the plurality of conductive plates can be connected to each other more precisely.

Hereinafter, connection members according to embodiments of the present disclosure will be described with reference to the drawings. Note that the present disclosure is not limited to these examples but is defined by the claims, and all modifications that come within the meaning and range of equivalency of the claims are intended to be embraced therein.

### Embodiment 1

An embodiment will be described below based on the drawings.

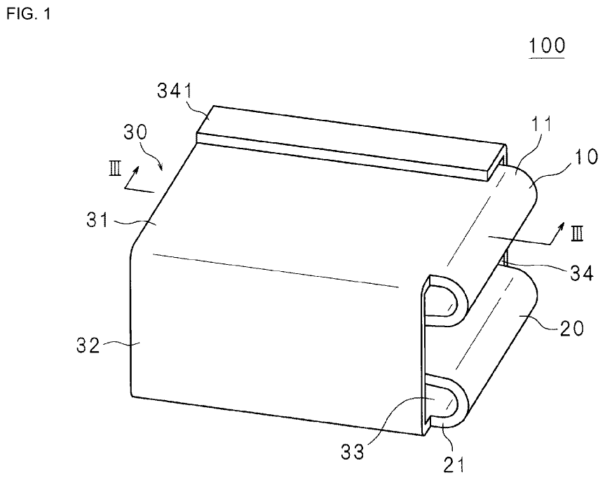

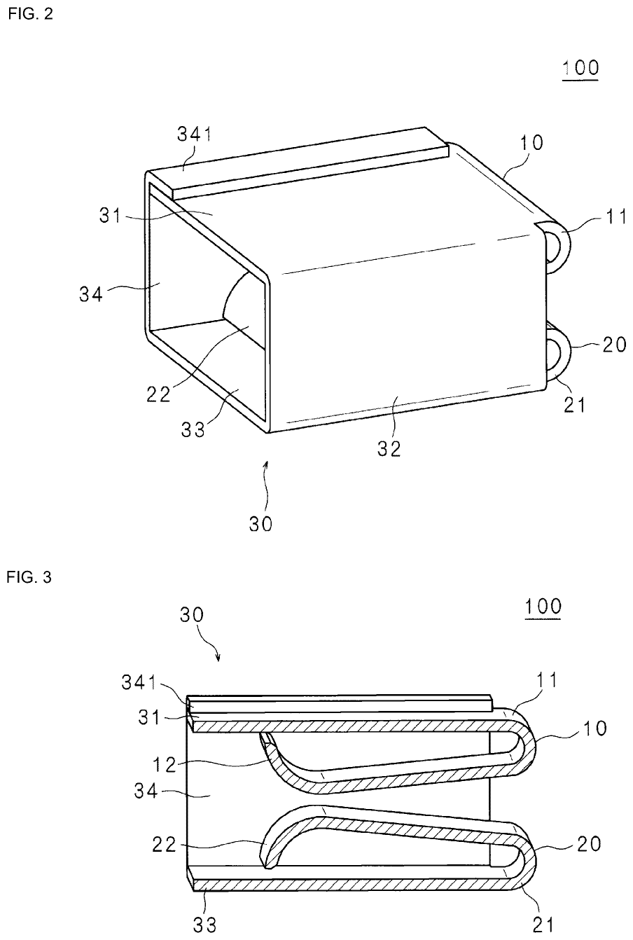

FIG. 1 is a perspective view showing a connection member 100 according to Embodiment 1, as viewed from one side; FIG. 2 is a perspective view of the connection member 100 according to Embodiment 1, as viewed from another side; and FIG. 3 is a cross-sectional view taken along line III-III in FIG. 1.

The connection member 100 according to Embodiment 1 is configured to electrically connect a plurality of conductive plates. For example, the connection member 100 holds a plurality of superposed bus bars from two opposite outer sides, thereby bringing main surfaces of the bus bars into contact with each other, and thus electrically connecting the plurality of bus bars to each other.

The connection member 100 includes a tubular frame 30 into which a plurality of conductive plates to be connected are to be inserted, as well as a first bent plate portion 10 (protruding portion) and a second bent plate portion 20 (protruding portion) that protrude into the tubular frame 30 and are configured to hold the plurality of conductive plates from opposite sides.

The tubular frame 30 has a quadrangular tubular shape with a rectangular shape in cross-sectional view, and is made of a material with excellent elasticity, such as steel. A first opposing wall 31 and a second opposing wall 33 that are opposite each other are provided with the first bent plate portion 10 and the second bent plate portion 20, respectively. The first opposing wall 31 and the second opposing wall 33 are rectangular, and long side edges of the first opposing wall 31 are connected to corresponding opposing long side edges of the second opposing wall 33 by side walls 32 and 34. The first opposing wall 31, the second opposing wall 33, and the side walls 32 and 34 are integrally formed. In other words, the tubular frame 30 is formed of a single sheet of plate material, and is produced by bending the plate material.

Note that an end portion 341 of the side wall 34 that is closer to the first opposing wall 31 is bent onto the first opposing wall 31 and covers an outer surface of the first opposing wall 31. Therefore, the first opposing wall 31 is prevented from opening in a direction away from the second opposing wall 33.

The first bent plate portion 10 and the second bent plate portion 20 are provided continuously at one end of the tubular frame 30 in a longitudinal direction. More specifically, the first bent plate portion 10 is continuous with one short side edge of the first opposing wall 31 in the longitudinal direction, and the second bent plate portion 20 is continuous with one short side edge of the second opposing wall 33 in the longitudinal direction.

The first bent plate portion 10 is formed of the same rectangular plate material as the tubular frame 30. An edge of the first bent plate portion 10 that is located on one end side of the first bent plate portion 10 in the longitudinal direction is continuous with the short side edge of the first opposing wall 31, and the first bent plate portion 10 is folded inward into the tubular frame 30. That is to say, the first bent plate portion 10 is bent into the tubular frame 30 at one end portion 11. Additionally, another end portion 12 of the first bent plate portion 10 that is located on the other end side of the first bent plate portion 10 in the longitudinal direction is curved toward the first opposing wall 31. In this case, an edge of the other end portion 12 is spaced apart from the first opposing wall 31 (see FIG. 3). The first bent plate portion 10 protrudes from the first opposing wall 31 into the tubular frame 30. For example, the radius of curvature of the other end portion 12 is greater than that of the one end portion 11.

The second bent plate portion 20, like the first bent plate portion 10, is formed of the same rectangular plate material as the tubular frame 30. An edge of the second bent plate portion 20 that is located on one end side of the second bent plate portion 20 in the longitudinal direction is continuous with the short side edge of the second opposing wall 33, and the second bent plate portion 20 is folded inward into the tubular frame 30. That is to say, the second bent plate portion 20 is bent into the tubular frame 30 at one end portion 21. Additionally, another end portion 22 of the second bent plate portion 20 that is located on the other end side of the second bent plate portion 20 in the longitudinal direction is curved toward the first opposing wall 33. In this case, an edge of the other end portion 22 is spaced apart from the second opposing wall 33 (see FIG. 3). That is to say, the second bent plate portion 20 has a reversed shape relative to the first bent plate portion 10, and the second bent plate portion 20 protrudes from the second opposing wall 33 into the tubular frame 30. For example, the radius of curvature of the other end portion 22 is greater than that of the one end portion 21.

As shown in FIG. 3, the first bent plate portion 10 and the second bent plate portion 20 face each other, and the distance between the one end portion 11 of the first bent plate portion 10 and the one end portion 21 of the second bent plate portion 20 is wider than the distance between the other end portion 12 of the first bent plate portion 10 and the other end portion 22 of the second bent plate portion 20. That is to say, in an intermediate region with respect to the longitudinal direction, the distance between the first bent plate portion 10 and the second bent plate portion 20 gradually decreases from the one end of the tubular frame 30 toward the other end. The tubular frame 30, the first bent plate portion 10, and the second bent plate portion 20 are integrally formed.

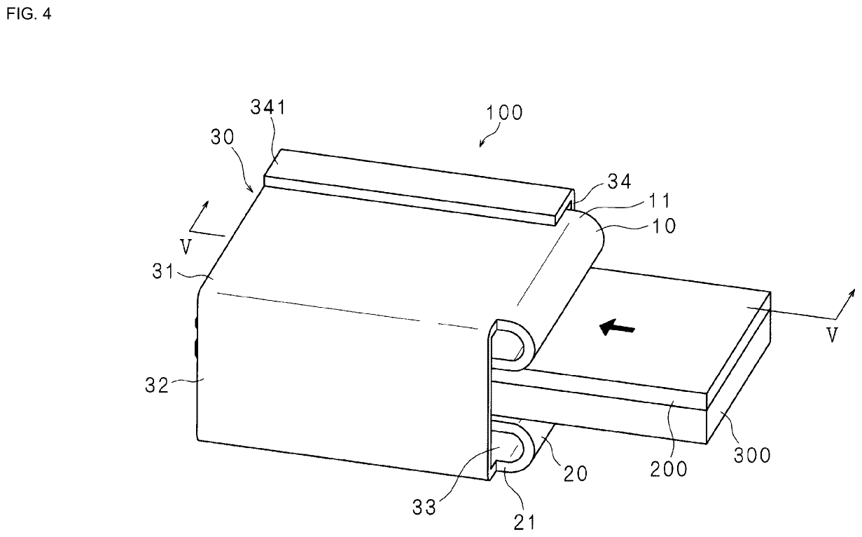

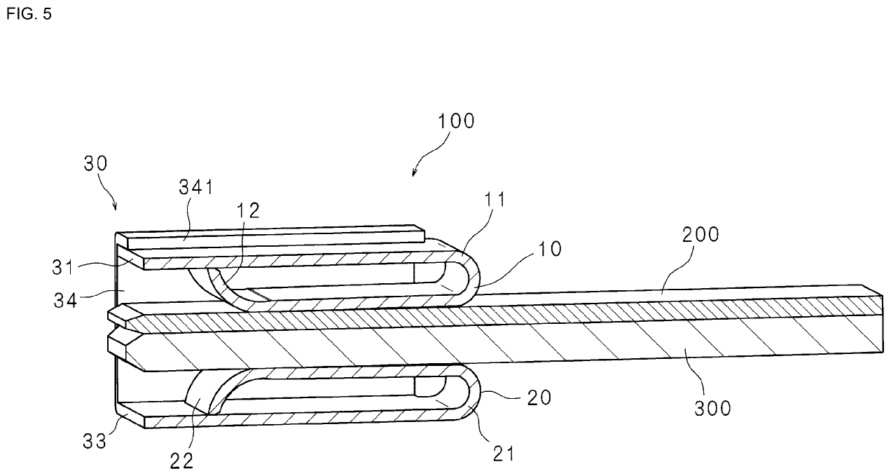

FIG. 4 is an explanatory diagram showing a state in which two superposed bus bars 200 and 300 are electrically connected to each other by the connection member 100 of Embodiment 1; and FIG. 5 is a cross-sectional view taken along line V-V in FIG. 4. The bus bars 200 and 300 are made of a conductive plate material, such as copper, and have rectangular main surfaces of the same size. However, the bus bar 200 has a smaller thickness than the bus bar 300.

A user superposes the bus bars 200 and 300 so that their main surfaces are in contact with each other, and pushes the bus bars 200 and 300 in this state into the connection member 100 (tubular frame 30) from the one end side of the tubular frame 30, that is, between the one end portion 11 of the first bent plate portion 10 and the one end portion 21 of the second bent plate portion 20 (see the arrow of FIG. 4).

As a result, the bus bars 200 and 300 are present between the first bent plate portion 10 and the second bent plate portion 20 while being superposed on top of each other. In this case, the first bent plate portion 10 and the second bent plate portion 20 deform toward the first opposing wall 31 and the second opposing wall 33, respectively, and thus, a restoring force is exerted to return them to their original shapes. Accordingly, the first bent plate portion 10 and the second bent plate portion 20 push the outer main surfaces of the superposed bus bars 200 and 300 from opposite sides, pressing the two bus bars against each other and thereby holding them.

More specifically, a flat central portion of the first bent plate portion 10 abuts against the outer main surface of the bus bar 200 and biases the bus bar 200 toward the bus bar 300, and a flat central portion of the second bent plate portion 20 abuts against the outer main surface of the bus bar 300 and biases the bus bar 300 toward the bus bar 200 (see FIG. 5). As a result, the inner main surfaces of the bus bars 200 and 300 are brought into contact with each other, and thus, the bus bars 200 and 300 are electrically connected.

Furthermore, as shown in FIG. 5, when the bus bars 200 and 300 are present between the first bent plate portion 10 and the second bent plate portion 20, the edge of the other end portion 12 of the first bent plate portion 10 spaced apart from the first opposing wall 31 abuts against the first opposing wall 31, and the edge of the other end portion 22 of the second bent plate portion 20 spaced apart from the second opposing wall 33 abuts against the second opposing wall 33. As described above, the other end portion 12 of the first bent plate portion 10 is curved toward the first opposing wall 31, and the other end portion 22 of the second bent plate portion 20 is curved toward the second opposing wall 33. Therefore, stress (restoring force) acting in an outward radial direction is further applied to the other end portion 12 of the first bent plate portion 10 and the other end portion 22 of the second bent plate portion 20. That is to say, the other end portion 12 of the first bent plate portion 10 and the other end portion 22 of the second bent plate portion 20 function as springs. The restoring force of the other end portion 12 and the other end portion 22 causes the bus bars 200 and 300 to be in stronger contact with each other.

Note that, to prevent positional deviation between the bus bars 200 and 300 when the user pushes the superposed bus bars 200 and 300 into the connection member 100 (tubular frame 30) from the one end side of the tubular frame 30, the bus bars 200 and 300 may be provided with an engaging portion and an engaged portion corresponding to the engaging portion.

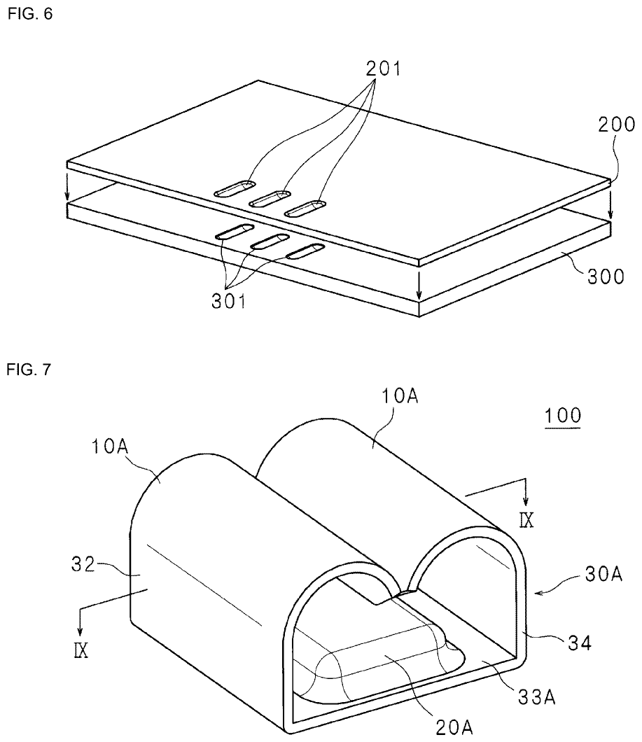

FIG. 6 is an exemplary illustration of an engaging portion 201 formed in the bus bar 200 and an engaged portion 301 formed in the bus bar 300.

Specifically, a long side end portion of the relatively thin bus bar 200 is embossed to form an engaging portion 201, which is recessed from the outer main surface of the bus bar 200 and protrudes from the inner main surface opposite the outer main surface. Also, the relatively thick bus bar 300 is embossed at a location that faces the engaging portion 201 of the bus bar 200 to form an engaged portion 301, which is recessed from the inner main surface of the bus bar 300. The engaging portion 201 and the engaged portion 301 have semicircular shapes in cross-sectional view, and the radius of curvature of the engaging portion 201 (protrusion) is greater than that of the engaged portion 301 (recess).

Therefore, when the bus bars 200 and 300 are superposed (see the arrows in FIG. 6), the engaging portion 201 and the engaged portion 301 engage with each other, so that the bus bars 200 and 300 are pushed into the tubular frame 30 with the engaging portion 201 and the engaged portion 301 being in engagement with each other (see the arrow in FIG. 4). Accordingly, while the connection between the bus bar 200 (engaging portion 201) and the bus bar 300 (engaged portion 301) is secured, the occurrence of positional deviation is suppressed when the bus bars 200 and 300 are pushed into the tubular frame 30.

Although the case where the engaging portion 201 and the engaged portion 301 are formed in the long side end portions of the bus bars 200 and 300 has been described as an example above, the present disclosure is not limited to this, and the engaging portion 201 and the engaged portion 301 may be formed in other locations, such as central portions of the bus bars 200 and 300.

As described above, with the connection member 100 of Embodiment 1, it is possible to electrically connect a plurality of conductive plates simply by superposing the conductive plates and pushing the superposed conductive plates into the connection member 100 (tubular frame 30). Therefore, the connection member 100 of Embodiment 1 can electrically connect the conductive plates more easily and at a low cost, without using any special device or the like.

Also, the connection member 100 of Embodiment 1 is configured such that the distance between the first bent plate portion 10 and the second bent plate portion 20 gradually decreases from the one end of the tubular frame 30 toward the other end along the longitudinal direction. Therefore, while the insertion of a plurality of superposed conductive plates into the tubular frame 30 can be facilitated, these conductive plates can be reliably held (connected) from opposite sides.

Although the case where the connection member 100 of Embodiment 1 has both the first bent plate portion 10 and the second bent plate portion 20 has been described as an example above, the present disclosure is not limited to this, and either one of them may be omitted.

Note that, although the case where the size of the plurality of conductive plates is such that the entire stack of the conductive plates can be pushed into the connection member 100 (tubular frame 30) has been described as an example above, the present disclosure is not limited to this. When the size of the plurality of conductive plates is such that the entire stack of the conductive plates cannot be pushed into the tubular frame 30, tabs may be formed on the individual conductive plates so that the superposed tabs can be pushed into the tubular frame 30.

### Embodiment 2

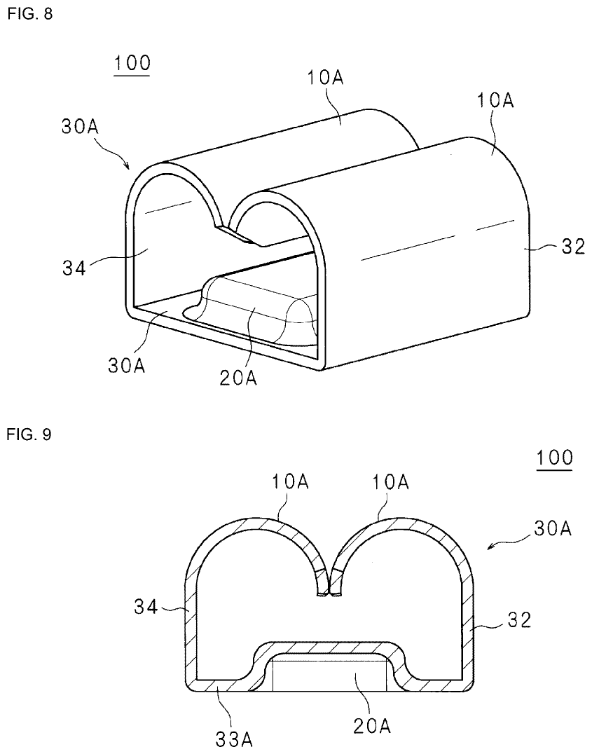

FIG. 7 is a perspective view showing a connection member 100 according to Embodiment 2, as viewed from one side; FIG. 8 is a perspective view of the connection member 100 according to Embodiment 2, as viewed from another side; and FIG. 9 is a cross-sectional view taken along line IX-IX in FIG. 7. For example, the connection member 100 according to Embodiment 2 holds a plurality of superposed bus bars from two opposite outer sides, thereby bringing main surfaces of the bus bars into contact with each other, and thus electrically connecting the plurality of bus bars to each other.

The connection member 100 includes a tubular frame 30A into which a plurality of conductive plates to be connected are to be inserted, as well as an embossed portion 20A (protruding portion) that protrudes into the tubular frame 30A and a semi-cylindrical portion 10A that is disposed facing the embossed portion 20A, the embossed portion 20A and the semi-cylindrical portion 10A being configured to hold the plurality of conductive plates from opposite sides.

The tubular frame 30A has a substantially tubular shape and is made of a material with excellent elasticity, such as steel. The tubular frame 30A has a flat plate portion 33A with a flat rectangular plate shape, and the embossed portion 20A is formed in a central portion of the flat plate portion 33A. A pair of semi-cylindrical portions 10A are provided in locations that face the flat plate portion 33A, and the pair of semi-cylindrical portions 10A are connected to the flat plate portion 33A by side walls 32 and 34. The flat plate portion 33A, the side walls 32 and 34, and the pair of semi-cylindrical portions 10A are integrally formed. In other words, the tubular frame 30A is formed of a single sheet of plate material, and is produced by bending and embossing the plate material.

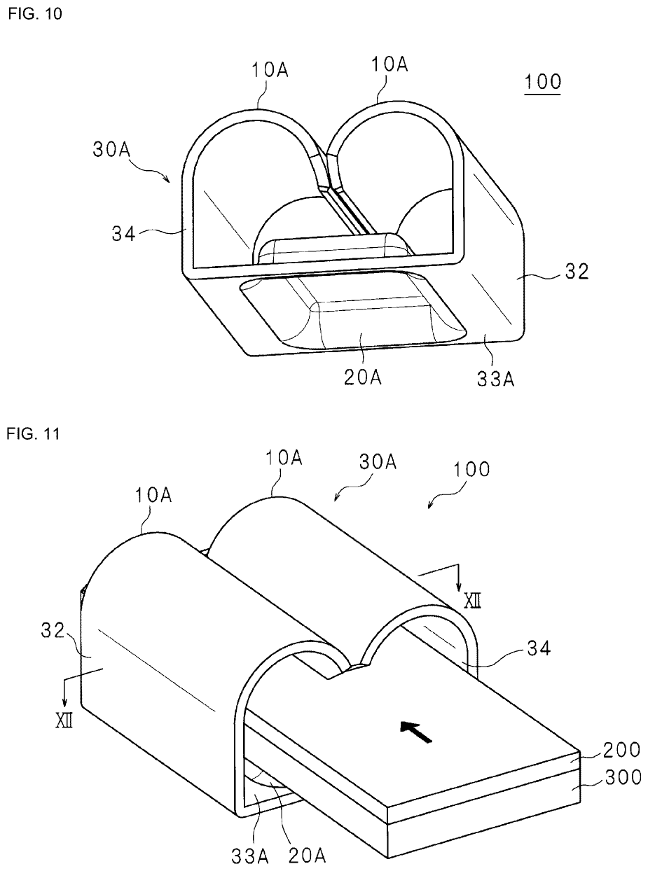

FIG. 10 is a perspective view of the connection member 100, showing the exterior of the flat plate portion 33A.

As described above, the embossed portion 20A is formed in the central portion of the flat plate portion 33A by locally raising the flat plate portion 33A through embossing. The embossed portion 20A protrudes from the flat plate portion 33A into the tubular frame 30A. That is to say, the embossed portion 20A forms a recess on the outer side of the flat plate portion 33A, and a protrusion on the inner side of the flat plate portion 33A. The embossed portion 20A is substantially rectangular in cross-sectional view taken along a direction parallel to the plane of the flat plate portion 33A, and has a protruding end surface that is a flat rectangular surface.

The side walls 32 and 34 are continuous with opposite long side edges of the flat plate portion 33A, respectively. The side walls 32 and 34 have strip-like shapes of the same size that extend along the long side edges of the flat plate portion 33A, and extend perpendicularly to the flat plate portion 33A. That is to say, the two long side edges of the flat plate portion 33A are continuous with one long side edge of the side wall 32 and one long side edge of the side wall 34, respectively.

As described above, the pair of semi-cylindrical portions 10A are provided in locations that face the flat plate portion 33A. More specifically, the semi-cylindrical portions 10A are continuous with the other long side edge of the side wall 32 and the other long side edge of the side wall 34, respectively. Each of the semi-cylindrical portions 10A has the shape of a semi-cylinder extending in the longitudinal direction of the flat plate portion 33A, and the pair of semi-cylindrical portions 10A are arranged side-by-side so as to be adjacent to each other in the radial direction.

In each semi-cylindrical portion 10A, out of two circumferential ends thereof that are opposite each other in the radial direction, one circumferential end is continuous with the other long side edge of the corresponding side wall 32 or 34. Additionally, the pair of semi-cylindrical portions 10A are separate from each other. In other words, the pair of semi-cylindrical portions 10A are individually continuous with, at one circumferential end, the respective side walls 32 and 34, as described above, and the other circumferential ends of the semi-cylindrical portions 10A are arranged so as to be adjacent to each other without being connected.

The pair of semi-cylindrical portions 10A have the same radius of curvature and are curved to protrude outward from the tubular frame 30A. That is to say, the other circumferential ends of the pair of semi-cylindrical portions 10A extend toward the embossed portion 20A and face the embossed portion 20A.

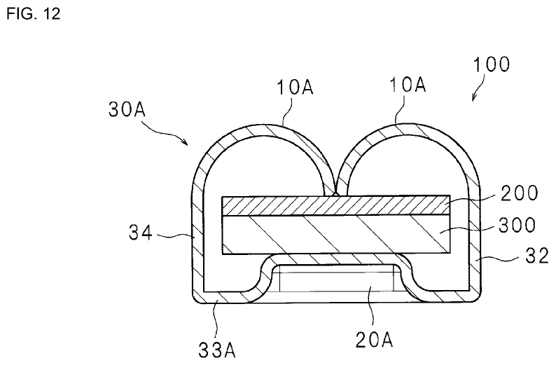

FIG. 11 is an explanatory diagram showing a state in which two superposed bus bars 200 and 300 are electrically connected to each other by the connection member 100 of Embodiment 2; and FIG. 12 is a cross-sectional view taken along line XII-XII in FIG. 11. The bus bars 200 and 300 are made of a conductive plate material, such as copper, and have rectangular main surfaces of the same size. However, the bus bar 200 has a smaller thickness than the bus bar 300.

The user superposes the bus bars 200 and 300 so that their main surfaces are in contact with each other, and pushes the bus bars 200 and 300 in this state into the connection member 100 (tubular frame 30A) from one end side of the tubular frame 30A (see the arrow in FIG. 11).

As a result, the bus bars 200 and 300 are present between the embossed portion 20A and the pair of semi-cylindrical portions 10A (the other circumferential ends) while being superposed on top of each other. In this case, each semi-cylindrical portion 10A deforms outward from the tubular frame 30A in a direction in which it faces the embossed portion 20A (hereinafter simply referred to as the “facing direction”), while the embossed portion 20A receives a pressing force acting outward from the tubular frame 30A in the facing direction. In response, a restoring force is applied to the semi-cylindrical portions 10A, which have curved shapes, to return them to their original shapes, while a repulsive force acting inward into the tubular frame 30A is generated in the embossed portion 20A, which forms the protrusion. Therefore, the pair of semi-cylindrical portions 10A and the embossed portion 20A push the outer main surfaces of the superposed bus bars 200 and 300 from opposite sides, pressing the two bus bars against each other and thereby holding them.

In other words, the other circumferential ends of the semi-cylindrical portions 10A abut against the outer main surface of the bus bar 200 and biases the bus bar 200 toward the bus bar 300, and the flat protruding end surface of the embossed portion 20A abuts against the outer main surface of the bus bar 300 and biases the bus bar 300 toward the bus bar 200 (see FIG. 12). As a result, the inner main surfaces of the bus bars 200 and 300 are brought into contact with each other, and thus, the bus bars 200 and 300 are electrically connected.

Note that, to prevent positional deviation between the bus bars 200 and 300 when the user pushes the superposed bus bars 200 and 300 into the connection member 100 (tubular frame 30A) from the one end side of the tubular frame 30A, the bus bars 200 and 300 may be provided with an engaging portion and an engaged portion corresponding to the engaging portion, as in Embodiment 1.

As described above, with the connection member 100 of Embodiment 2, it is possible to electrically connect a plurality of conductive plates simply by superposing the conductive plates and pushing the superposed conductive plates into the connection member 100 (tubular frame 30A). Therefore, the connection member 100 of Embodiment 2 can electrically connect the conductive plates more easily and at a low cost, without using any special device or the like.

Furthermore, the connection member 100 of Embodiment 2 uses the tubular frame 30A, which is open at both ends in the longitudinal direction, and this allows for the insertion of a plurality of conductive plates into the tubular frame 30A from both end sides in the longitudinal direction. Therefore, the degree of freedom for operation can be increased.

Furthermore, in the connection member 100 according to Embodiment 2, the pair of semi-cylindrical portions 10A are separate from each other. Accordingly, the degree of freedom for deformation of the individual semi-cylindrical portions 10A in the facing direction is increased. In other words, the semi-cylindrical portions 10A can deform without being affected by each other. Therefore, even when the surface of a target conductive plate is not flat and includes a local protrusion, the semi-cylindrical portions 10A can deform independently of each other, increasing the number of contact points with the target conductive plate. Thus, an appropriate electrical connection between the conductive plates can be achieved.

Although the case where the connection member 100 of Embodiment 2 has a single embossed portion 20A formed in the flat plate portion 33A has been described as an example above, the present disclosure is not limited to this, and a plurality of smaller embossed portions 20A may be formed in the flat plate portion 33 A.

Although the case where the pair of semi-cylindrical portions 10A of the connection member 100 of Embodiment 2 are separate from each other has been described as an example above, the present disclosure is not limited to this. The pair of semi-cylindrical portions 10A may be connected to each other, or in other words, the other circumferential ends may be connected to each other.

Although the case where the pair of semi-cylindrical portions 10A are curved to protrude outward from the tubular frame 30A has been described as an example above, the present disclosure is not limited to this. The pair of semi-cylindrical portions 10A may be curved to protrude inward into the tubular frame 30A.

Components that are the same as those of Embodiment 1 are given the same reference numerals, and detailed descriptions thereof are omitted.

The technical features (constituent elements) described in Embodiments 1 and 2 may be combined with one another, and new technical features can be formed by combining them.

The embodiments disclosed herein should be considered in all respects as illustrative and not restrictive. The scope of the present disclosure is defined by the claims, not by the meaning given in the foregoing description, and all modifications that come within the meaning and range of equivalency of the claims are intended to be embraced therein.

The matters described in the embodiments can be combined with one another. Additionally, the independent and dependent claims set forth in the claims can be combined with one another in any combination, regardless of the form of recitation. Furthermore, although the form (multiple dependent claim form) in which a claim recites two or more other claims is used in the claims, the claims is not limited to this form. The form in which a multiple dependent claim (multi-multi claim) recites at least one multiple dependent claim may also be used in the claims.

1. A connection member configured to connect a plurality of superposed conductive plates, comprising:
a tubular frame into which the conductive plates are to be inserted;
a first bent plate portion that is continuous with an edge of a first wall of the tubular frame and bent into the tubular frame; and
a second bent plate portion that is continuous with an edge of a second wall of the tubular frame and bent into the tubular frame, the second wall being opposite the first wall,
wherein the first bent plate portion and the second bent plate portion face each other, and
an end portion of the first bent plate portion and an end portion of the second bent plate portion are curved toward the first wall and the second wall, respectively.

2. (canceled)

3. (canceled)

4. The connection member according to claim 1,
wherein the end portion of the first bent plate portion and the end portion of the second bent plate portion are spaced apart from an inner surface of the tubular frame.

5. (canceled)

6. A connection member configured to connect a plurality of superposed conductive plates, comprising:
a tubular frame into which the conductive plates are to be inserted;
an embossed portion formed by locally raising a first wall of the tubular frame; and
a pair of semi-cylindrical portions provided on an opposite side to the first wall and arranged side-by-side in a radial direction,
wherein each of the semi-cylindrical portions is curved to protrude inward into the tubular frame.

7. (canceled)

8. (canceled)

9. The connection member according to claim 6,
wherein the pair of semi-cylindrical portions are separate from each other.
